(19) United States
(12) Patent Application Publication
(10) Pub. No.: US 2025/0065590 A1
(43) Pub. Date: Feb. 27, 2025

(54) ENVELOPE HAVING A CLOSING FLAP, METHOD AND MACHINE FOR MANUFACTURING SUCH AN ENVELOPE

(71) Applicant: HOLWEG GROUP, Molsheim (FR)

(72) Inventor: Cédric Ritondo, Molsheim (FR)

(21) Appl. No.: 18/560,245

(22) PCT Filed: May 9, 2022
(86) PCT No.: PCT/EP2022/062442

§ 371 Date: Nov. 10, 2023

(30) Foreign Application Priority Data
May 12, 2021 (FR) FR2105063

(51) Int. Cl. B31B 70/81; B31B 70/14; B31B 70/62

(52) U.S. Cl. CPC B31B 70/8123; B31B 70/146; B31B 70/62; B31B 70/813

(57) ABSTRACT

An envelope formed from a sheet of flexible material and including: a lower section, an upper section superposed on the lower section, the sections being joined together by lateral edges, leaving an opening between the lateral edges, a protective strip on a layer of closing adhesive, the layer of closing adhesive being intended to ring about the closure of the envelope after the protective strip has been removed, and at least one precut region that is able to be detached from the envelope, the protective strip and the layer of closure adhesive extending at least partially over the precut region. Associated method and production machine.

### TECHNICAL FIELD

The invention concerns envelope-type flexible bags made from a sheet of flexible material, paper in particular, with a closing tab. It also concerns the addition of a protection strip on the tab to protect an adhesive area. It also concerns a method and a machine for manufacturing such envelopes.

### PRIOR ART

Industrial processes for manufacturing bags made of flexible materials such as paper or synthetic material have been known for a long time. For example, document FR 1 270 400 describes a machine and a process in which a strip is unreeled and formed into a tube. The tube is flattened in such a way that it comprises a first and a second wall, then the tube is cut into sections in such a way that at each end of the section there is a tab which prolongs the first or second wall. In a folding step, the tab is folded and bonded while being turned down on to the other wall than the one it extends from. It is thus possible to manufacture bags at a high rate with a large variety of materials and formats.

Document FR 786 579 shows several examples of this technique. In particular, in FIGS. 4 to 6 it shows a manufacturing process in which the strip of paper includes transversal perforated lines at regular intervals, with a line at the centre and two lines, axially offset with respect to the central line on each edge of the strip. The tube is formed by folding each edge over the central part and sticking two edges together along a central join in such a way that the central perforations form two transversal lines respectively offset on one and the other faces of the tube. The tube thus formed passes between a pair of drive rollers that drive the tube at a constant speed. The front part of the tube is gripped by the folding device which comprises a contra- rotary drum and folding roller. The drum and the folding roller rotate at a peripheral speed higher than that of the pair of drive rollers. The folding roller comprises a bar that is able to pinch the front of the tube against the drum, in such a way that the front part of the tube is pulled and separated by tearing along the perforations to form a section. On separation, owing to the offsets between the lines of perforations, a rear tab is thus formed on the section, as well as a front tab at the end of the tube. This front tab will be situated on the next section. The front tab is folded by the folding device on to an adhesive-coated area to close the front part of the section. To achieve this, the roller also comprises a folding blade, just behind the bar, which pushes the tube into a pincher carried by the drum in such a way as to fold the tube.

In a variant, the tube is formed with bellows linking the first and second walls. Document WO 2016 097310 A1 shows an example of such bags. This document also shows a machine that is used to form an envelope from the tube using two stations each of which comprises a pair of contra-rotary cylinders whose work makes it possible to make the separation into sections and tear off a waste piece to reveal a tab at the front of the section on the same wall as the rear tab. Thus, after folding the tabs, they are applied to the same wall.

Such bags can be used as mail envelopes. In this case, the rear tab has an adhesive coat, for example protected by means of protection such as a sheet of siliconized paper. This sheet can be removed, revealing the adhesive coat. The rear tab serves as a closing flap which can be folded to bring the adhesive coat against the wall opposite the one that the rear tab extends from, in such a way that the adhesive coat sticks to the wall, sealing the envelope. Thus, the wall that the tabs extend from has a smooth face when the tabs are stuck to the opposite face to close the envelope. When the envelope is received by its addressee, the latter tears the end of the envelope, for example at the level of the flap, to access the latter's content.

When manufacturing the bags, the removal of the waste piece is a limitation: on the one hand, it can be seen this is a limiting factor for the speed of bag manufacturing, and on the other hand the large amount of waste pieces is always a constraint that must be managed. Furthermore, the adjustment of such a machine requires a high level of technical expertise. A great deal of time is required to make the adjustment when changing the format of the bags, particularly in the case of a change of width, because the means of perforation will have to be changed.

The above-mentioned document FR 1 270 400 also describes a manufacturing process that can be used to make envelopes. A continuous sheet of paper is unreeled and then cuts are made on the edges in such a way as to create symmetrical bonding seams with respect to a longitudinal middle of the sheet and extending along an area of the sheet called the upper flap. The seams are folded longitudinally on the sheet and coated with adhesive on the upper face, opposite the upper flap. The sheet is cut into sections, for example by a clean cut and folded along a transversal crease to delimit a lower flap that is folded over the upper flap. The lower flap is thus bonded to the seams and the container is delimited between the upper flap and the lower flap. The cut is made in such a way that a tab remains prolonging the upper flap opposite the transversal crease.

The fact of making a clean cut instead of tearing gives a bag with a quality that is perceived as being better, the edge being sharper. However, this process also generates waste when making the lateral seams.

It is possible to apply a coat of closing adhesive protected by a protection strip on the tab of such envelopes. However, the coat of closing adhesive cannot extend to the lateral edges of the tab. So, once the envelope has been closed, there always remains a part of the tab that is not maintained on the wall of the envelope. In addition, it is not easy to grasp the protection strip because it is necessary to separate it beforehand from the wall on which it is applied, for example by bending this wall.

Document EP-3564146-Al shows a bag manufacturing process that is quite similar to that in FR 1 270 400, but differs in that no cut is made in the edge. The flaps folded one on the other are bonded together along the edges. The process therefore does not generate any waste, but the useful width of the bag is reduced by the width of the areas bonded to each other. Furthermore, this type of bonding is more fragile because the constraints for separating one flap from the other are concentrated on the edge of the adhesive area.

### DESCRIPTION OF THE INVENTION

The invention aims to provide an envelope whose closing is of good quality and easy to achieve. It also aims to provide a process, and a machine for manufacturing at high speed such envelopes with or without bellows, that does not generate any waste, and is easy to adjust.

With these goals in view, the object of the invention is an envelope formed by at least one sheet of flexible material and comprising:
a lower flap,
an upper flap superposed over the lower flap, the flaps being attached to each other by lateral edges leaving an opening between the lateral edges,
at least one protection strip on a coat of closing adhesive, the coat of closing adhesive being designed to ensure the closing of the envelope after removal of the protection strip,
said envelope being characterised by the fact it comprises reinforced means of attachment bonding the precut area to the protection strip in a stronger way with respect to the attachment between the protection strip and the coat of closing adhesive.

Such an envelope is used by starting with the removal of the precut area and taking the protection strip with it to uncover the coat of closing adhesive. The coat of adhesive that remains on the envelope extends to the edge of the remaining part which, in the case of a closing flap, makes it possible to bond it fully and ensures that part of the tab is not left unmaintained on the wall of the envelope. Furthermore, the removal of the protection strip is made easier. You just have to grasp the precut area over its thickness, then pull the whole to remove the protection strip by breaking away the precut area. A precut area can be provided at each end of the protection strip. The flexible material could, for example, be paper with varying grammages, for example between 40 and 150 g/m², synthetic material, textile or a combination of these materials. The protection strip could, for example, be made of paper with on one face a siliconized coat which comes into contact with the closing adhesive, which would make it possible to separate the protection strip without tearing it and leaving the closing adhesive on the envelope.

As per an improvement, the precut area comprises a coat of reinforced adhesive covered by a protection strip, the protection strip adhering better to the coat of reinforced adhesive than to the coat of closing adhesive. The removal of the protection strip is made even easier because it suffices to pull on the precut area, even without pinching the protection strip with the precut area. The protection strip remains stuck to the precut area owing to the coat of reinforced adhesive.

As per an alternative improvement, the precut area is folded onto the back of the protection strip, the coat of closing adhesive on the precut area being stuck to said back of the protection strip, the back of the protection strip adhering better to the coat of adhesive than the face opposite the back adheres to the coat of closing adhesive. The same adhesive is used to obtain a different degree of bonding, by using a different quality of adhesion depending on whether the face used is coated or not. The protection strip comprises a coated face that has an anti-adhesive property and a non-coated face opposite, to which the adhesive adheres better. The precut area could, for example, be part of a hem or of a cheek of a bellows such as described hereinafter.

As per an accomplishment mode, the flaps are attached along the lateral edges by bellows, each bellows comprising two cheeks.

As per a disposition, in the case of bellows, the precut area extends over the whole width of the bellows at least. Thus, the part of the bellows along the protection strip will be removed fully with the protection strip.

As per an improvement, the envelope comprises at least two protection strips in parallel in a transversal direction, and at least one precut area for each protection strip. Thus, the envelope is reusable being closed firstly after removal of the first of the protection strips and of the precut areas that are attached to it, then a second time after the removal of the second protection strip and of the precut areas that are attached to it. A weakening line can be provided between the two strips to obtain opening of the envelope more assuredly without tearing the part on which the second strip is situated.

As per one characteristic, the edges of the upper flap and of the lower flap at the level of the opening are offset with respect to each other to leave part of the tab extending over the lower flap between said edges, the protection strip extending over the tab area. A tab is thus formed which makes it possible to close the envelope by folding the tab and sticking it to the upper flap.

As per an accomplishment mode, the coat of closing adhesive is subdivided into a first, second and third part extending transversely, the lower flap comprising a first and second weakening line between the first and second part, respectively the second and third part, the protection strip comprising a third weakening line aligned with the first weakening line and a fourth weakening line aligned with the second weakening line, the weakening lines extending across the precut area. Such an envelope being reusable insofar as the envelope can be closed a first time by removing the protection strip to uncover the first part of the coat of closing adhesive and stick it to the upper flap, then the envelope can be opened by tearing off the strip of material delimited between the first and second weakening lines and the part of the protection strip situated between the third and fourth lines. Lastly the envelope can be closed a second time by uncovering the third part of the coat of closing adhesive by removing the rest of the protection strip to stick it to the upper flap.

As per an accomplishment mode, the protection strip and the coat of closing adhesive are covered at least in part by the upper flap. Thus, when the protection strip is removed, it will be possible to stick the upper and lower flaps together from the inside. This makes it possible to obtain a particularly well-sealed closing.

As per an improvement to this accomplishment mode, the protection strip and the coat of closing adhesive extend over the whole periphery of the opening. Thus, after removal of the protection strip, the closing of the envelope is particularly well sealed, not leaving any open passage at the level of the opening.

As per an accomplishment mode, the upper flap and the lower flap extend out of the same sheet shaped into a tube and bonded edge to edge. Such an envelope could for example be obtained as per a manufacturing process given in document WO 2016 097310 A1.

As per an improvement to this accomplishment mode, the edges of the flaps along the opening are aligned. The protection strip is then placed inside the bag, which makes it possible to stick the flaps to each other without folding.

As per another improvement, the edge of the upper flap along the opening extends beyond the lower flap, the precut area extending over the whole width of the upper flap set back from the edge of the lower flap. The piece of waste that is usually separated in the manufacturing process remains in place in this version. The coat of closing adhesive and the protection strip extend over this waste piece which will be removed by the user of the envelope, by removing the protection strip and the waste piece together.

As per another accomplishment mode, the upper flap and the lower flap extend out of the same sheet of material folded along a transversal folding crease, perpendicularly to the lateral edges of the flaps, towards an interior face, the envelope comprising a hem formed on each lateral edge, the hem of the upper flap being stuck to the hem of the lower flap on seam faces. For example, this corresponds to the manufacturing process described in document FR 1 270 400 in FIGS. 3 and 4, but with the difference that the edges are not cut out but hemmed continuously.

As per an accomplishment mode, the hem is linked to a central part of the flap by means of a cheek folded onto the central part, in such a way that a bellows is formed by two cheeks brought together by hems stuck to each other. The same technique as described above also applies to obtain envelopes with bellows. The bellows are made by assembling two cheeks, stuck to the middle of the bellows. The cheeks are obtained by longitudinally folding the edges of the sheet of flexible material.

As per an improvement, the hem is stuck to the face opposite the seam face solely along either the upper flap or the lower flap. Thus, considering one of the edges of the manufactured envelope, the two hems are superposed and stuck to each other and, in addition, one of them only is stuck to the cheek where applicable, or to the internal face of the flap. It can be noted that this disposition makes it possible to stress the bonding essentially by sliding one hem over the other, whereas without bonding, the constraint is concentrated on the edge of the bonding and tears the bonding more easily.

The object of the invention is also an envelope manufacturing process, whereby:
at least one sheet of flexible material is unreeled as a continuous sheet in a longitudinal direction,
precut lines are marked delimiting the precut areas on the sheet,
closing adhesive is applied extending on both sides of the pre-cutting lines, and a protection strip that covers the coat of closing adhesive at least outside the precut areas,
the strip is separated into sections, each section is closed to form an envelope as per one of the above-mentioned claims, the envelope having an opening bordered by the precut areas.

The coat of closing adhesive, the protection strip and the precut lines are made flat and by operations during the continuous unreeling of the sheet, which is suitable for high manufacturing rates. The formation of an envelope is then achieved by folding and separating the sheet into sections.

As per a manufacturing mode:
a hemmer is used to form a hem on each edge of the sheet before folding and adhesive is applied to the hems over at least one length of an upper flap or a lower flap on one seam face.
using folding means a fold is formed on the sheet along a transversal folding crease to fold down the upper flap onto the lower flap against an interior face of the sheet, the folding means bringing each edge hem against hem by the seam face in such a way as to obtain bonding of the hems to each other to bring the upper flap and the lower flap together along the edges,
the sheet is cut with a transversal cut made by cutting means to form a section before or after folding the flaps onto each other, the section forming the envelope at the end of these operations.

This process makes it possible to produce envelope-type bags without producing waste, so without limitation on the production rate caused by having to manage the removal of such waste. The process uses the principle described in document FR 1 270 400 but without having to cut the edges. Indeed, the edges are folded over their whole length to form the hems and the latter are folded one onto the other after application of adhesive to assemble the two folded flaps one on the other. Cutting can be achieved by a clean-cutting means, that is to say by shearing, which gives a good perceived cutting quality. Cutting could also be obtained by tearing, that is to say by traction on a portion that has perforations initiating a cutting line. The cutting system is the same whatever the width of the bag to be made. It is therefore easy to change the width unlike for the manufacture of pouch- type bags by tearing off a waste piece which requires the installation of a special tool to make the perforations specific to the width.

As per an accomplishment mode, the transversal cut extends over the protection strip to separate a first part of the protection strip on the upper flap and a second part on the lower flap, the first part and the second part being superposed after folding that is at least partial. A two-part protection strip is thus made making it possible to obtain a coat of closing adhesive on the interior face of the two flaps, in such a way as to make it possible to stick them together after removal of the protection strip.

As per an accomplishment mode, the first and third weakening lines, respectively the second and fourth weakening lines are marked together, after application of the protection strip on the sheet.

As per an accomplishment mode, for the manufacture of an envelope formed from a tube, transversal perforation lines are made on the strip delimiting one rear end of a first envelope and a front tab of a second envelope following the first between a central line in the transversal direction and a bottom line from which the front tab protrudes towards the front, the bottom line also delimiting the precut area, the sheet is shaped into a tube, then the first and second envelopes are separated by axial traction on the tube by gripping the first envelope on the precut areas so that the separation is made along the central line and the bottom line.

The object of the invention is also a machine for manufacturing flexible envelopes, characterised by the fact it comprises:
unwinding means for unreeling at least one sheet of flexible material as a continuous sheet in a longitudinal direction,
marking means for marking precut lines on the strip to delimit the precut areas,
application means for applying a coat of closing adhesive and a protection strip at regular intervals extending on both sides of the precut lines on the coat of closing adhesive on the sheet,
separation means for separating the sheets into sections along the rear edge of the section,
folding means for closing each section to form an envelope as per one of the above claims with an opening along the rear edge bordered by the precut areas,
the machine being configured to implement the process such as described previously.

### BRIEF DESCRIPTION OF THE FIGURES

The invention will be better understood and other features and advantages will appear on reading the following description, the description referring to the attached drawings among which:

FIG. 1 is a perspective view of an envelope as per a first accomplishment mode;

FIG. 2 is a view similar to [FIG. 1] of part of the envelope in [FIG. 1] after removal of a protection strip;

FIG. 3 is a view similar to [FIG. 1] of part of the envelope in [FIG. 1] after closing;

FIG. 4 is a perspective view of an envelope as per a second accomplishment mode;

FIG. 5 is a view similar to [FIG. 4] of part of the envelope in [FIG. 4] after removal of a protection strip;

FIG. 6 is a perspective view of an envelope as per a third accomplishment mode;

FIG. 7 is a view similar to [FIG. 6] of part of the envelope in [FIG. 6] after removal of a first protection strip;

FIG. 8 is a view similar to [FIG. 6] of part of the envelope in [FIG. 6] after closing of the envelope;

FIG. 9 is a top view of an envelope as per a fourth accomplishment mode;

FIG. 10 is a perspective view of an envelope as per a fifth accomplishment mode;

FIG. 11 is a sectional view as per plane XI in [FIG. 10];

FIG. 12 is a perspective view of an envelope as per a sixth accomplishment mode;

FIG. 13 is a view similar to [FIG. 12] of part of the envelope after removal of a protection strip;

FIG. 14 is a perspective view of an envelope as per a seventh accomplishment mode;

FIG. 15 is a schematic view of a machine as per a first accomplishment mode;

FIG. 16 is a schematic view of a machine as per a second accomplishment mode;

FIG. 17 is a top view of a sheet during its transformation for the manufacture of an envelope as per the first and second accomplishment modes;

FIG. 18 is a top view of a sheet during its transformation for the manufacture of an envelope as per the third accomplishment mode;

FIG. 19 is a top view of a sheet during its transformation for the manufacture of an envelope as per the fourth accomplishment mode;

FIG. 20 is a top view of a sheet during its transformation for the manufacture of an envelope as per the fifth accomplishment mode;

FIG. 21 is a top view of a sheet during its transformation for the manufacture of an envelope as per the sixth accomplishment mode;

FIG. 22 is a top view of a sheet during its transformation for the manufacture of an envelope as per the seventh accomplishment mode;

### DETAILED DESCRIPTION

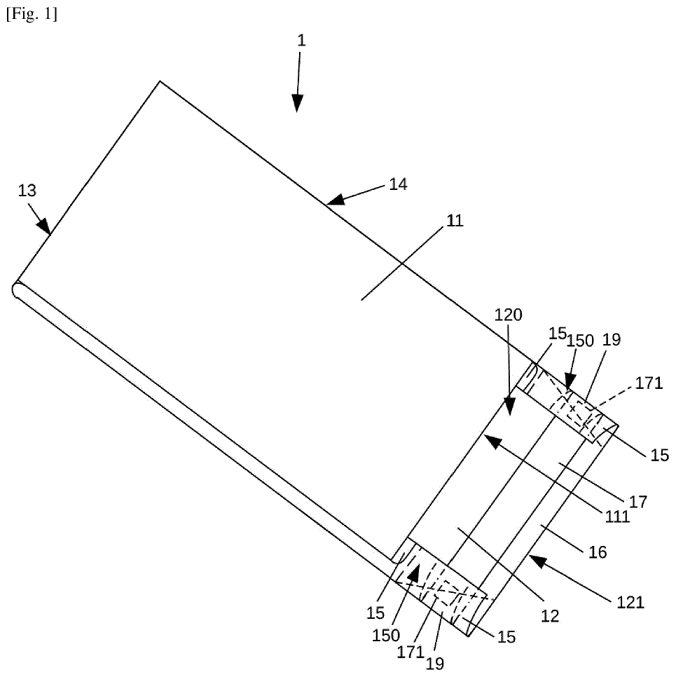

An envelope 1 as per the invention's first accomplishment mode is shown in FIGS. 1 to 3. Such an envelope 1 is made from a sheet of flexible material such as paper and comprises a lower flap 12, an upper flap 11 superposed over the lower flap 12, flaps 11, 12 being taken from the same sheet (M) of material folded along a transversal folding crease 13 perpendicular to the lateral edges 14 of the flaps, towards an interior face 120. The envelope 1 comprises a hem 15 formed on each lateral edge 14, the flaps 11, 12 being linked to each other by the lateral edges 14 by the fact the hem 15 of the upper flap 11 is stuck to the hem 15 of the lower flap 12 on seam faces 150. An opening between the lateral edges 14 remains to allow the envelope 1 to be filled. The upper 111 and lower 121 edges of the upper flap 11 and of the lower flap 12 are offset with respect to each other at the level of the opening to leave a tab area 16 extending over the lower flap 12 between said edges.

The envelope I also comprises a protection strip 17 extending over the tab area 16 on a coat of closing adhesive 170. The coat of closing adhesive 170 is designed to ensure the closing of the envelope 1 after removal of the protection strip 17 and folding of the tab area 16 onto the upper flap 11.

The envelope I also comprises two precut areas 19 along the opening that can be detached from the envelope 1. The protection strip 17 and the coat of closing adhesive 170 also extend over the precut area 19. The precut area 19 comprises a coat of reinforced adhesive 171 covered by the protection strip 17 so that the protection strip 17 adheres better to the coat of reinforced adhesive 171 than to the coat of closing adhesive 170.

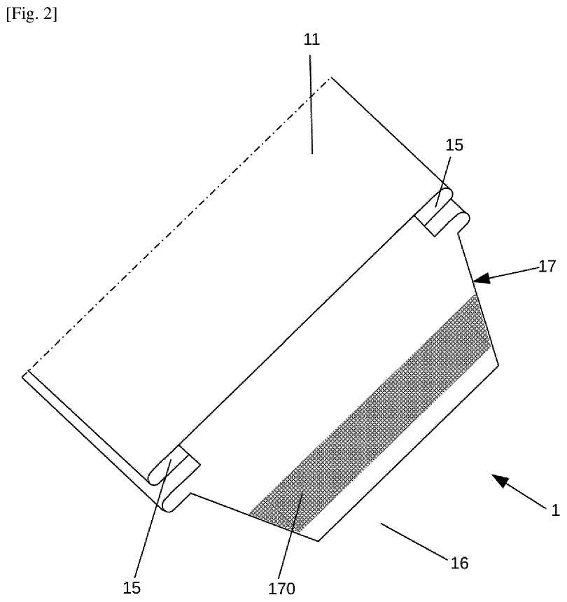

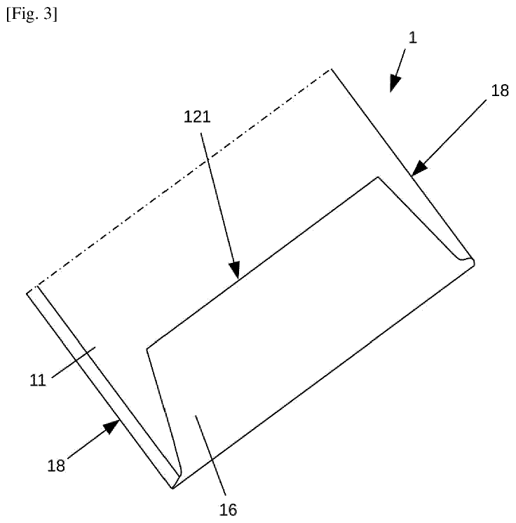

When the user of envelope 1 wants to use it after having filled it, they must successively grasp the precut areas 19 while gripping the protection strip 17 and pull to detach the precut areas 19 from the envelope 1, then completely remove the protection strip 17. The coat of closing adhesive 170 on the tab area 16 then remains bare, as shown in [FIG. 2]. The user can then fold the tab area 16 by folding it onto the upper flap 11 to close the envelope 1, as shown in [FIG. 3].

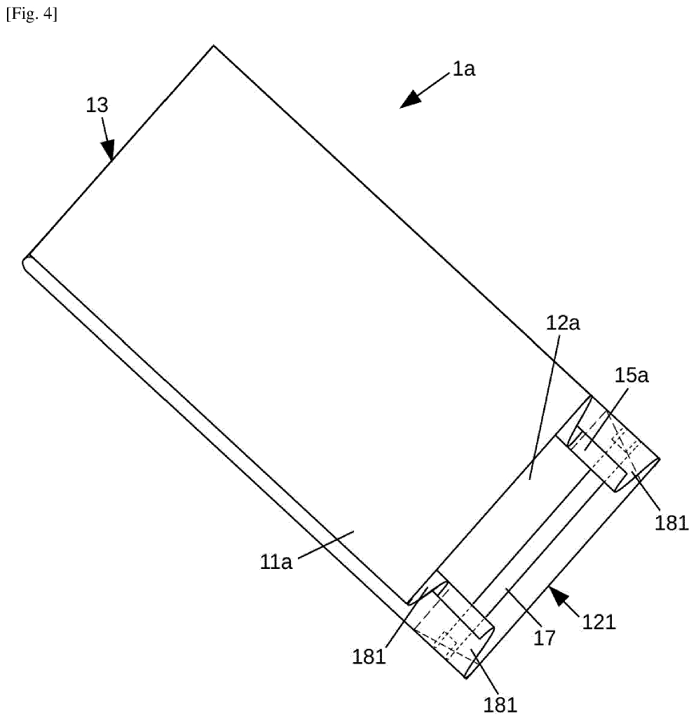

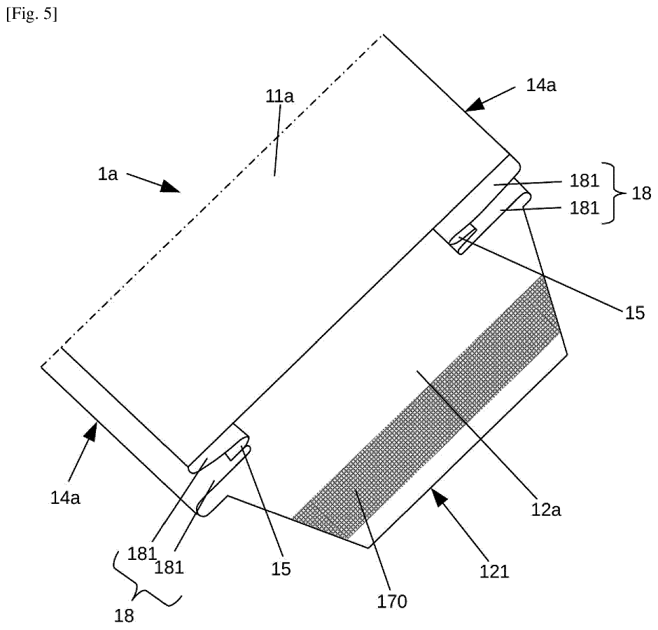

In a second accomplishment mode, shown in FIGS. 4 and 5, the envelope 1a differs from that of the first accomplishment mode in that the flaps 11a, 12a are linked to each other along the lateral edges 14a by two bellows 18, each bellows 18 comprising two cheeks 181. Considering the section of an edge of a flap, the central part, the cheek and the hem 15 form a sort of Z which is flattened during manufacturing but can be deployed when using the envelope 1. The cheeks 181 are linked to each other in the middle of the bellows 18 by sticking the hems to their seam face 150. One of the hems is also bonded to the cheek from which it extends, on the face opposite the seam face 150. The precut area 19 extends over the whole width of the cheek of the lower flap 12.

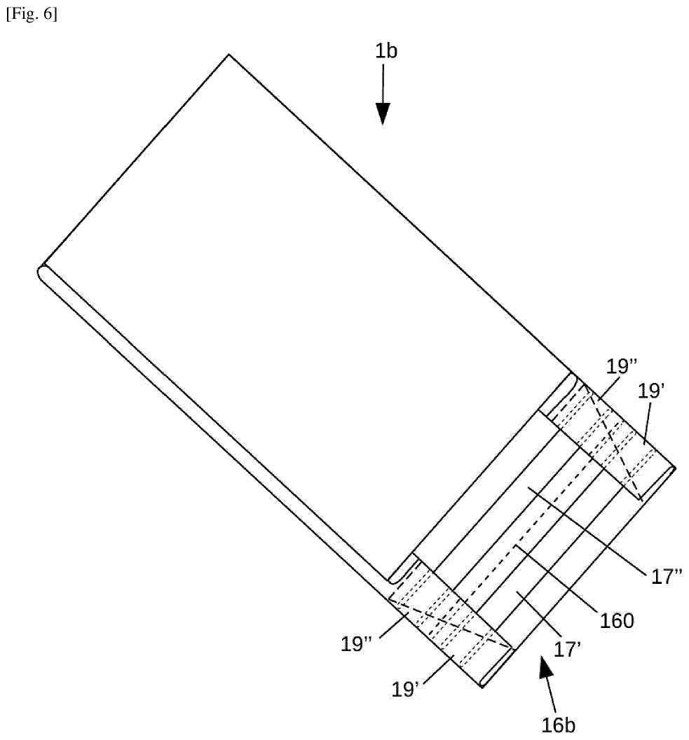

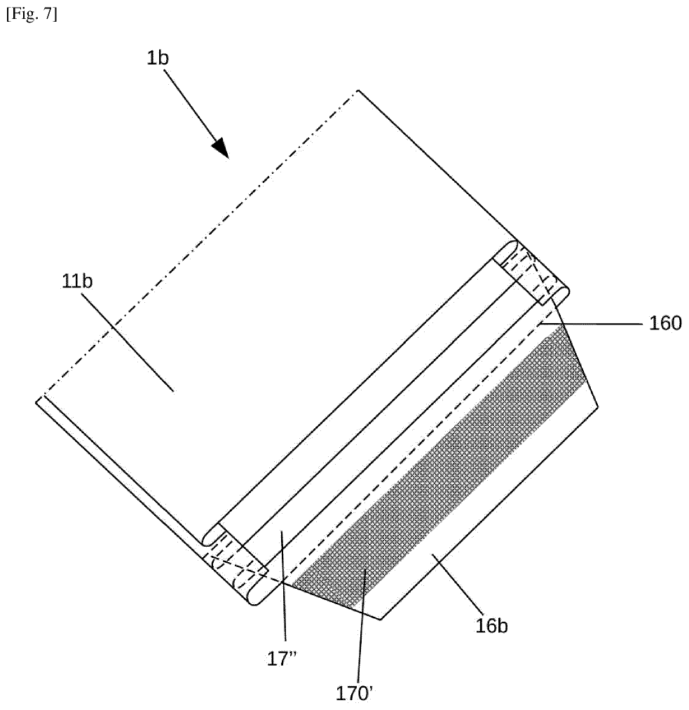

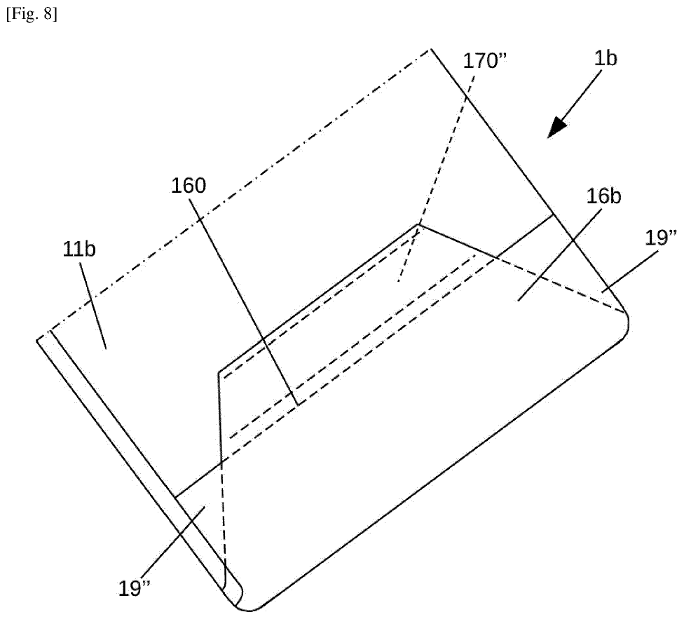

As per a third accomplishment mode, the envelope 1b differs from that of the first accomplishment mode in that it comprises at least two protection strips 17′, 17″ in parallel in a transversal direction, and at least one precut area 19′, 19″ for each protection strip 17′, 17″, as shown in FIGS. 6 to 8. The tab area 16b includes a transversal weakening line 160. In use, the user removes the outermost protection strip 17′, as shown in [FIG. 7], and folds the tab area 16b onto the upper flap 11b as shown in [FIG. 8]. The coat of closing adhesive 170′ uncovered by said protection strip 17′ serves to stick the tab 16b. This envelope 1b can be opened by tearing the part stuck along the weakening line 160, and then by closing the envelope 1b again by removing the second protection strip 17″, to obtain closing as shown in [FIG. 3]

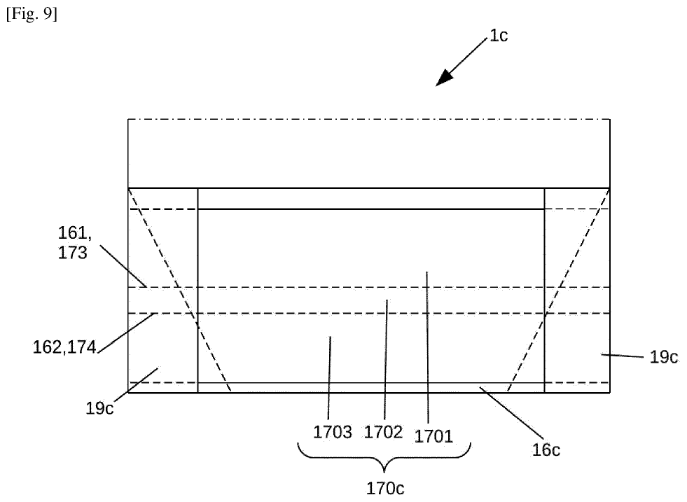

With a fourth accomplishment mode, the envelope 1c shown in [FIG. 9] differs from that of the first mode of accomplishment in that the coat of closing adhesive 170c is subdivided into a first, second and third part 1701, 1702, 1703 extending transversely. In its tab area 16c, the lower flap 12c comprises a first and second weakening line 161, 162, between the first and second parts 1701, 1702, respectively the second and third parts 1702, 1703. The protection strip 17 comprises a third weakening line 173 aligned with the first weakening line and a fourth weakening line 174 aligned with the second weakening line 162. The weakening lines 161, 162, 173, 174 extend across the precut area 19c.

When using such an envelope 1, a user puts the content, not shown, into the envelope 1c passing it through the opening, then detaches the third part of the protection strip 1703, including the precut areas 19, by tearing it along the fourth weakening line 174, leaving the first and second parts 1701, 1702 of the protection strip 17 in place. They fold down the tab 16c by folding it and press the third part of the coat of closing adhesive 1703 onto the upper flap 11 in such a way as to obtain adhesion. The envelope 1 is then closed and ready to be sent.

When they receive the envelope 1c, the addressee pulls on the whole formed by the second part of the strip situated between the weakening lines 161, 162 and the corresponding tab area 16 linked by the second part of adhesive 1702. The part that is detached forms a strip that separates the tab 16c into two parts one of which remains stuck to the upper flap 11, and the other which opens and creates the opening.

The envelope 1c can be reused by the addressee. To do this, they remove the first part of the protection strip to uncover the remaining coat of closing adhesive 1701, fold the tab 16c as previously to stick it on the upper flap 11.

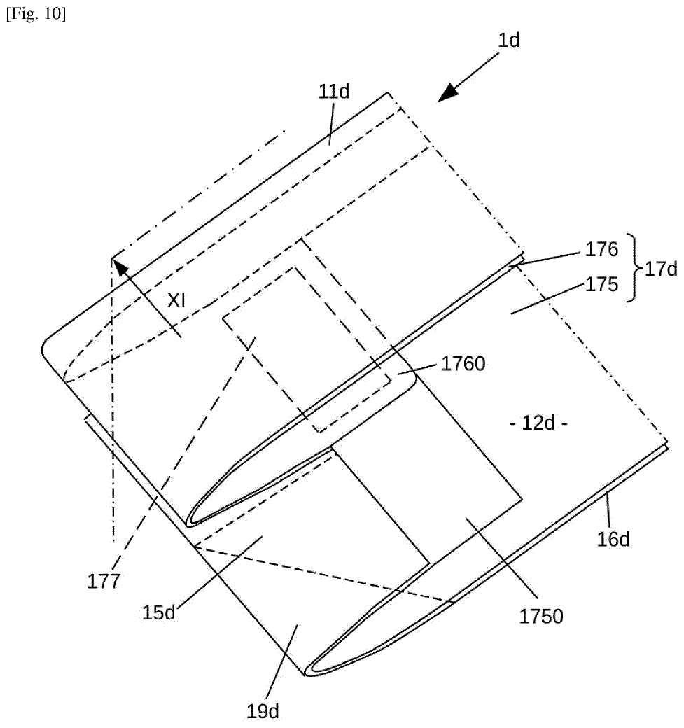

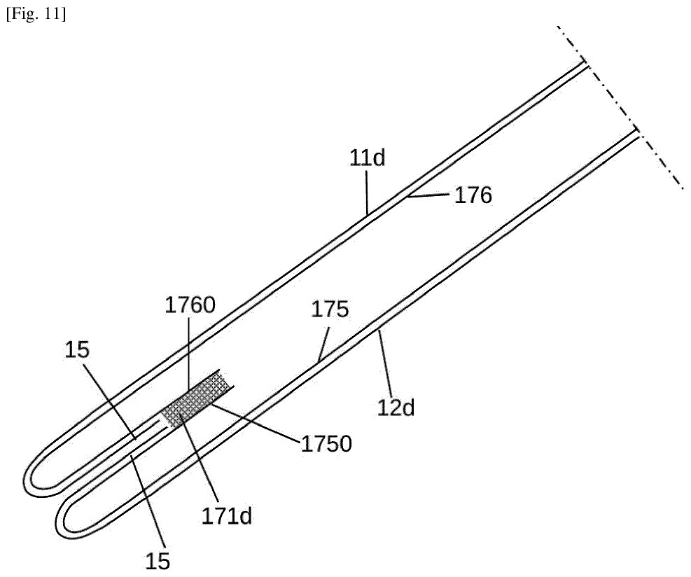

With a fifth accomplishment mode, the envelope 1d differs from that of the first accomplishment mode in that the protection strip 17d and the coat of closing adhesive 170d are covered at least in part by the upper flap 11, in this case they extend over the whole periphery of the opening, as shown in FIGS. 10 and 11. The protection strip 17d is made in two parts 175, 176 bonded to each other by a stronger adhesive than that of the coat of closing adhesive 170 in a unifying area 177. This unifying area 177 is situated on the sections 1750, 1760 of the protection strip 17 which extend beyond the hems 15d and into an area where the flaps 11d, 12d overlap. When using it, the user grasps the corner of the tab area 16 to detach the precut areas 19d, firstly pulling along the part of the protection strip 175 on the lower flap 12 then the part 176 on the upper flap 11. They can then press the flaps 11d, 12d together to stick one to the other at the level of the opening and also fold the tab area 16donto the upper flap 11 to make it stick.

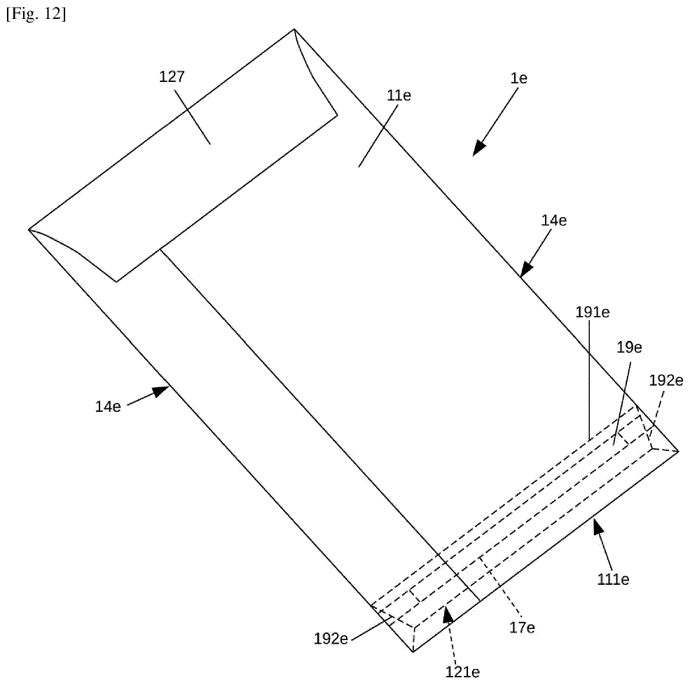

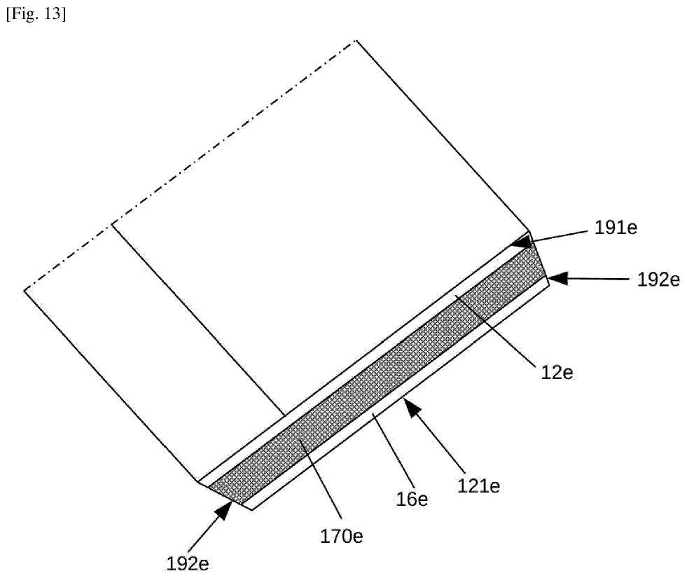

With a sixth way of making envelope 1, shown in FIGS. 12 and 13, the upper flap 11 and the lower flap 12 extend from the same sheet (M) shaped into a tube and bonded edge to edge and flattened. The envelope 1e is closed by a tab 127 extending from the lower flap folded, and stuck onto the upper flap 11e, in a manner known per se. Furthermore, the upper edge 111e of the upper flap 11ealong the opening protrudes from the lower flap 12e, the precut area 19e extending over the whole width of the upper flap 11e set back from the lower edge 121e of the lower flap 12e as far as a precut line 191e. The precut line 191e extends over the whole width of the upper flap 11e set back from the lower edge, as well as over the lower flap 12e reaching the lower edge 121e by a slanting line 192e along each lateral edge 14e. The protection strip 17e extending over the lower flap 12ebetween the lower edge 121e and the part of the precut line 191e on the upper flap 11 also covering the slanting lines 192e. When using this envelope le, the user pulls on the corner of the opening to detach the precut area 19e, that is to say the part of the upper flap 11e between the upper edge 111e and the precut line 191e, in such a way as to remove the protection strip 17 and uncover a new tab 16e comprising the coat of closing adhesive 170e, as shown in [FIG. 13]. The user then just has to fold this tab 16e to stick it to the upper flap 11e and thus close the envelope 1e.

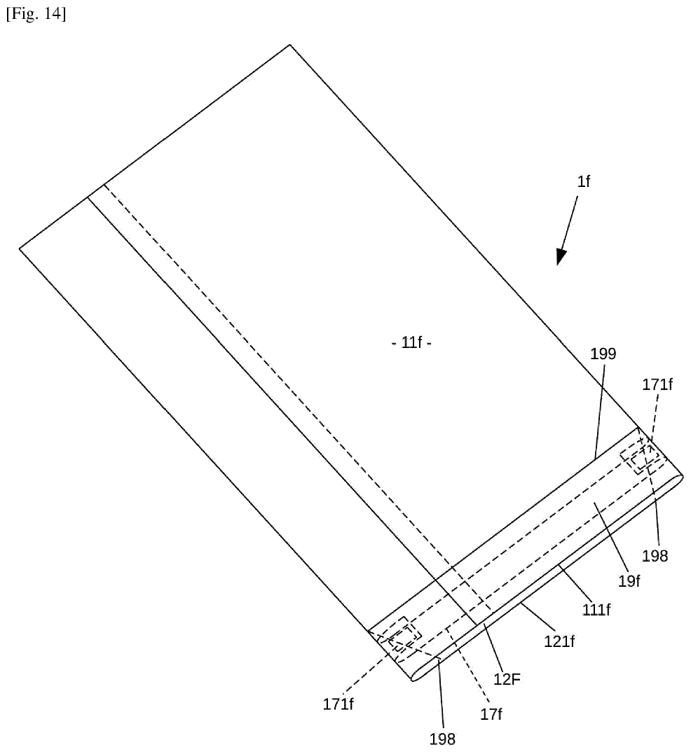

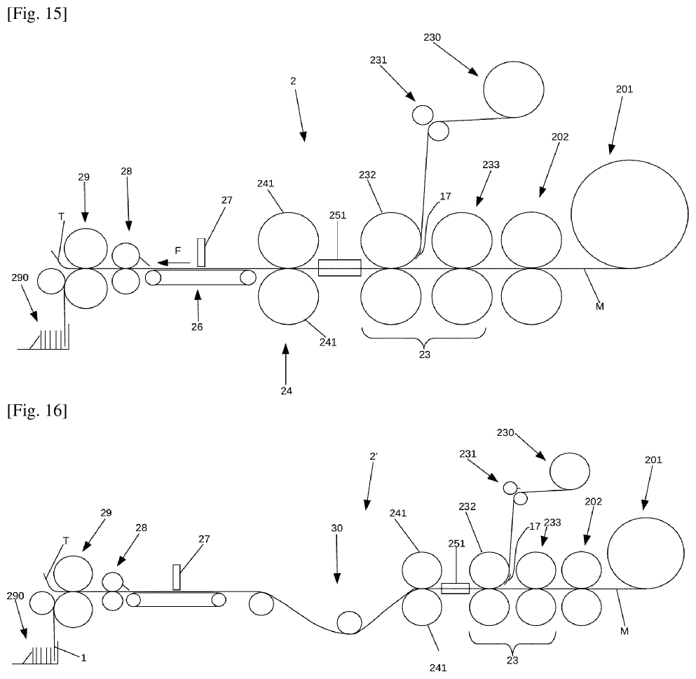

As per a seventh accomplishment mode, shown in [FIG. 14], the envelope If differs from that of the sixth accomplishment mode in that the lower and upper edges 111f, 121f are superposed. The bottom is formed by known means, not described here, making it possible to make a welded flat bottom, a square bottom or a hexagonal bottom, etc. A ninth segment of precut line 199 extends transversely over the upper flap 11f and two eighth segments extend from the ends of the ninth segment to the edge 121f of the lower flap 12f. When using this envelope 1f, the user pulls on the precut area 19f to detach it, that is to say on the part of the upper flap 11f between the upper edge 111f and the precut line 199, in such a way as to remove the protection strip 17f and uncover a new tab comprising the coat of closing adhesive. An envelope similar to the one in [FIG. 13] is obtained.

[FIG. 15] shows schematically a machine for making envelopes as per the first to fifth accomplishment modes. The machine 2 comprises:
a first unwinding means 201 for unreeling the continuous sheet M of flexible material in a longitudinal direction F;
marking means 202 for marking precut lines on the sheet M delimiting the precut areas 19;
application means 23 for applying a coat of closing adhesive 170 and a protection strip 17 on the coat of closing adhesive on the sheet M at regular intervals;
intake means 24 configured to exert a traction force on the sheet M of continuous material;
a hemmer 251 for each edge M1, M2, to form a hem 15 on each edge of the sheet M upstream of the intake means 24;
transport means 26 for guiding the sheet downstream of the intake means 24;
application means 27 for applying adhesive to the hems 15 on at least a length of the lower flap 12 or of the upper flap 11 on one seam face 150;
first cutting means 28 serving as means of separation for cutting the sheet M with a transversal cut to separate a section forming the envelope 1 at the end of the operations;
assembly means, for bringing together the upper flap 11 and the lower flap 12 along the edges, performed by folding means 29 to form a fold in the sheet M along a transversal folding crease 13, to fold the upper flap 11 down onto the lower flap 12 against an interior face 120 of the sheet M, and to bring for each edge the hem 15 against the hem 15 by the seam face 150 in such a way as to obtain adhesion of the hems 15 together to bring the upper flap 11 together with the lower flap 12 along the edges M1, M2;
stacking means 290, for stacking the envelopes downstream of the folding means 29.

The application means 23 comprises a second unwinding means 230 for unreeling a sheet of protection material comprising a face coated with an anti-adhesive coating, a cutting station 231 for forming protection strips 17 from the sheet of protection material and an application roller 232 for bringing the protection strip onto the sheet M with the anti-adhesive face on the areas coated with adhesive. The application means 23 also comprises an adhesive application means 233 for applying the adhesive areas 170, 171 upstream of the application roller 232.

The intake means 24 is made with a pair of counter-rotary rollers 241 driven by a motor, not shown.

The application means 27 consists for example of nozzles intermittently injecting adhesive.

The first cutting means 28, the folding means 29 and the stacking means 290 are conventional and are not described here. The various parts are driven in rotation by a single motor and synchronous mechanical transmissions, such as cog belts or gears, or by several individual but electronically synchronised motors, or a combination of the two solutions.

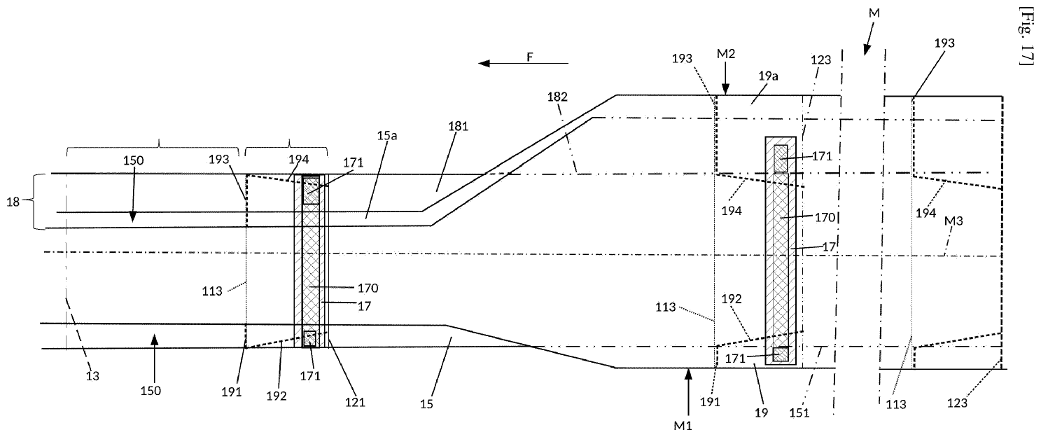

A machine 2′ conforming to a second application mode, shown in [FIG. 16], is provided to make envelopes with bellows 18. It differs from that of the first accomplishment mode in that a cheek formation station 30 is also provided downstream of the intake means 24 and configured to also form a cheek 181 on each edge M1, M2 of the sheet M.

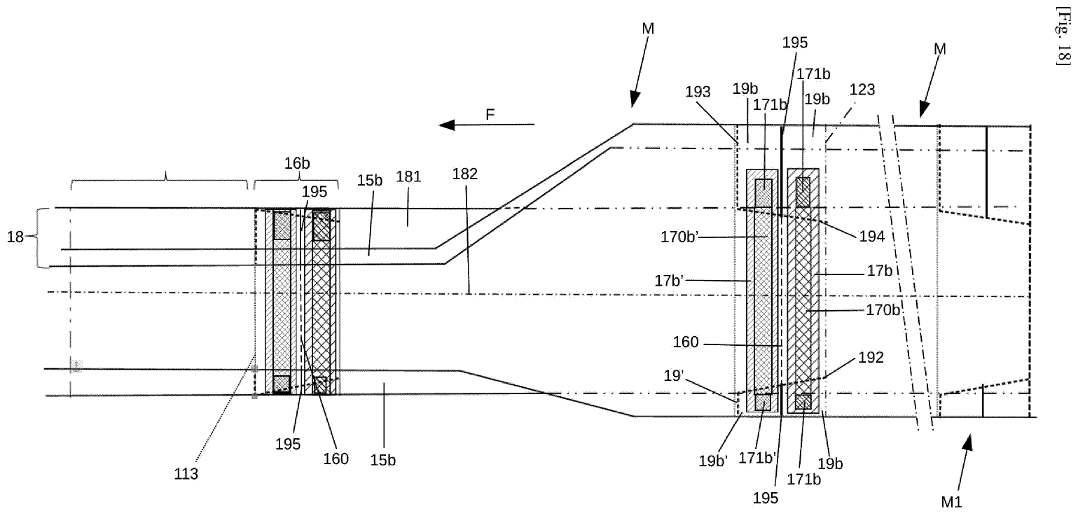

The machine 2 performs the following steps of the process for manufacturing envelope 1 as per the first accomplishment mode:
unreeling of the sheet M of flexible material in a longitudinal direction F by the unwinding means 201,
marking of the precut lines delimiting the precut areas 19 on the sheet M by the marking means 202,
application of the closing adhesive 170 which extends on both sides of the precut lines and of the reinforced adhesive 171 on the precut areas 19 and application of a protection strip 17 over the closing adhesive 170 and the reinforced adhesive 171 by the application means 23,
formation of a hem 15 with the hemmer 251 on each edge M1, M2 of the sheet M,
application of adhesive to the hems 15 on one seam face 150, over twice the length of the upper flap 11 by means of the adhesive application means 27,
separation of the sheet M into sections T by the cutting means 28 by transversal cutting,
using the folding means 29, folding of the sheet M along a transversal folding crease 13 to fold the upper flap 11 onto the lower flap 12 against an interior face 120 of the sheet M, the folding means bringing hem 15 against hem 15, for each edge, by the seam face 150 in such a way as to obtain the bonding of the hems to each other to bring the upper flap 11 together with the lower flap 12 along the edges M1, M2 so as to form the envelope 1 with the section T.

[FIG. 17] shows schematically the sheet M of flexible material when it is in the machine, being unreeled from the right of the figure to the left towards the cutting means. The lower part of the figure, below a middle line M3, represents one half of the sheet M during the formation of an envelope 1 without bellows as per the first accomplishment mode, the other half being symmetrical with respect to the middle line M3. The upper part represents the half of the sheet M during the formation of an envelope 1 with bellows 18, as per the second accomplishment mode for making envelope 1, the other half being symmetrical with respect to the middle line M3. The sheet M of material is shown flat on the right-hand part of the figure. A longitudinal dash and double-dot line represents the future crease of hem 151 or also, for the upper part of the figure, the future crease of the cheek 182. A transversal dotted line 113 represents the position of the first edge 111 when the first flap 11 is folded. A transversal dash and double-dot line indicates the transversal cut separating one section of sheet M.

Concerning the first accomplishment mode, the precut lines comprise a first segment 191 extending transversely at the level of the future first edge 113 from the edge of the sheet M to the future crease of the hem 151 and a second segment 192 linked to the first segment 191 and extending slanting to the future transversal cut 123. As already indicated previously, the segments are made symmetrically with respect to the middle line M3. Some closing adhesive 170 is applied creating a coat of closing adhesive 170 partially covering the second segments 192 between the future creases of the hem 151 and the reinforced adhesive 171 is applied in the prolongation of the closing adhesive 170 on the future hem 15. The protection strip 17 is applied extending transversely and completely covering the adhesive areas 170, 171.

Further to the left, the formation of the hem 15 is shown by folding the edge Ml of sheet M along the longitudinal crease of hem 151. The end of the protection strip 17 is thus also folded at the same time as hem 15. The hem is coated with adhesive beforehand at intervals by application means on the hemmer. The coating is done over a length corresponding to that of the upper flap. After the formation of the hem, it is stuck to the upper flap. At the left-hand end, a triple-dash and double-dot line represents the folding crease 13 between the upper flap 11, not shown, and the lower flap 12 on which the upper flap 11 will be folded by aligning the upper edge with the dotted line 113. The hem 15 presents a seam face 150 which is coated with adhesive, in such a way that after folding, the hem 15 along the upper flap 11 is stuck to the hem 15 along the lower flap 12. The sheet M is cut, usually before folding, to detach the section T which will form the envelope 1 as per the first accomplishment mode after folding and bonding the hems 15.

In a variant of the first accomplishment mode, not shown, the strip of material used to make the protection strips comprises a face coated with an anti-adhesive coating over a width corresponding to that of the coat of closing adhesive, the edges of the strip of material being left as is. The reinforced adhesive areas receive the same adhesive as the closing adhesive areas and the parts of the protection strip that do not have an anti-adhesive coat. The adhesion thus obtained in the reinforced adhesive areas is stronger than in the closing adhesive areas, which is the goal being sought.

In a variant of the first accomplishment mode, not shown, the strip of material used to make protection strips only extends between the future creases of the hem 151, leaving bare the coat of adhesive 171 which extends over the precut areas 19. When the cheek or the hem is folded over the back of the protection strip 17, they adhere strongly to each other. When the precut areas are detached, they take the protection strip with them baring the coat of closing adhesive 170.

Concerning the second accomplishment mode, the precut lines comprise a third segment 193 extending transversely at the level of the future edge from the edge of the sheet M to the future crease of the cheek 182 and a fourth segment 194 linked to the first segment 191 and extending slanting to the future cutting line. Closing adhesive is applied creating a coat of closing adhesive 170 partially covering the fourth segments 194 between the future cheek creases 182, and the reinforced adhesive 171 is applied in the prolongation of the closing adhesive 170 on the future cheek 181. The protection strip 17a is applied extending transversely and completely covering the adhesive areas. Further to the left we show the formation of the cheek 181 and of the hem 15a by longitudinally folding the edge of sheet M2 as per a Z-shaped profile along the cheek crease 182 and the hem crease 151. The end of the protection strip 17a is thus also folded at the same time as cheek 181. On the left-hand end, a three-dash and two-dot line represents the folding crease 13 between the upper flap 11a, not shown, and the lower flap 12a on which the upper flap 11a will be folded and aligning the upper edge with the dotted line. The hem 15a has a seam face 150 which is coated with adhesive, in such a way that after folding, the hem 15a along the upper flap 11a is stuck to the hem 15a along the lower flap 12a. The sheet M is cut, generally before folding, to detach a section which will form the envelope 1 as per the second accomplishment mode after the folding and sticking of the hems 15a.

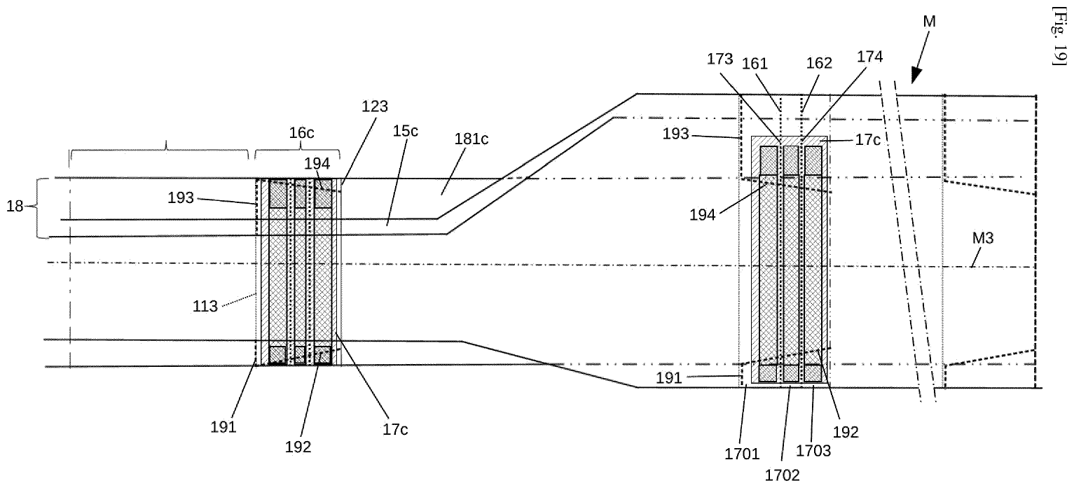

With reference to [FIG. 18], similar to [FIG. 17], the manufacture of an envelope 1b has been shown as per the third accomplishment mode in the lower part, and a variant with bellows 18 in the upper part, not described previously. The precut lines are similar to those in [FIG. 17], but completed by a fifth segment 195 extending transversely from the edge to the second segment 192 between the future first edge 113 and future cutting line 123. In addition to the previous adhesive areas 170b, 171b and the protection strip 17b extending into the precut areas 19b, closing adhesive 170b′ and reinforced adhesive 171b′ are applied to the tab 16b extending onto the precut area 19b′ delimited between the first and fifth segments 191, 195, as well as the second protection area 17b′ in parallel with the first protection strip 17b. A weakening line 160 is made at the same time as the precut lines and extends between the fifth segments 195. The rest of the formation of the envelope 1 is similar to the example described with respect to [FIG. 17].

In a variant that is not shown, the protection strip 17b is in one piece and covers the two adhesive areas 170b, 170b′. The weakening line 160 and the fifth segments are made together at the same time as a line weakening the protection strip 17b superposed over the weakening line 160, after application of the protection strip 17b on the sheet M.

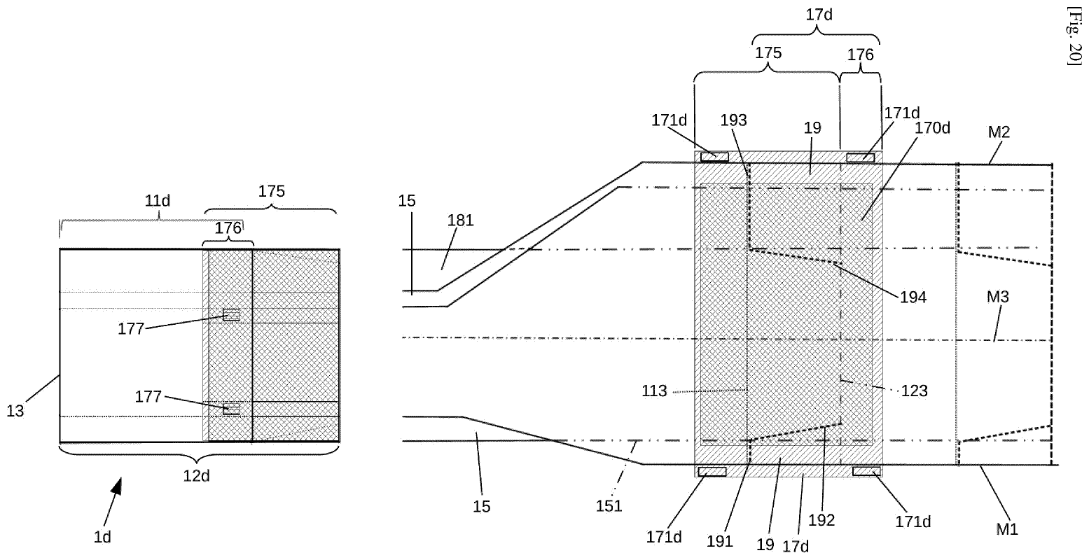

With reference to [FIG. 19], for the manufacture of an envelope 1c as per the fourth accomplishment mode, or of a variant of the fourth accomplishment mode with bellows 18, the precut areas 19c are identical to those in [FIG. 17]. However, the coat of closing adhesive 170 is divided into a first, second and third area, 1701, 1702, 1703 extending transversely and in parallel with each other. The protection strip 17 is applied to the tab 16c over all of the coats of adhesive 1701, 1702, 1703. Then, weakening lines are made, for example by means of lines of perforations. Thus, on the lower flap 12, the first and second weakening lines 161, 162 are made together between the first and second parts 1701, 1702, respectively the second and third parts 1702, 1703. Likewise, the third weakening line 173 aligned with the first weakening line 161 is made together with the fourth weakening line 174 aligned with the second weakening line 162. As a result, the weakening lines extend through the precut area 19c. The weakening lines are made after application of the protection strip, to mark the weakening lines together on the tab area 16c and the protection strip 17c. They can be made before or after the formation of the hems 15c and of the cheeks 181c, even after the folding of the flaps. The left-hand part of [FIG. 18] is similar to that of [FIG. 17].

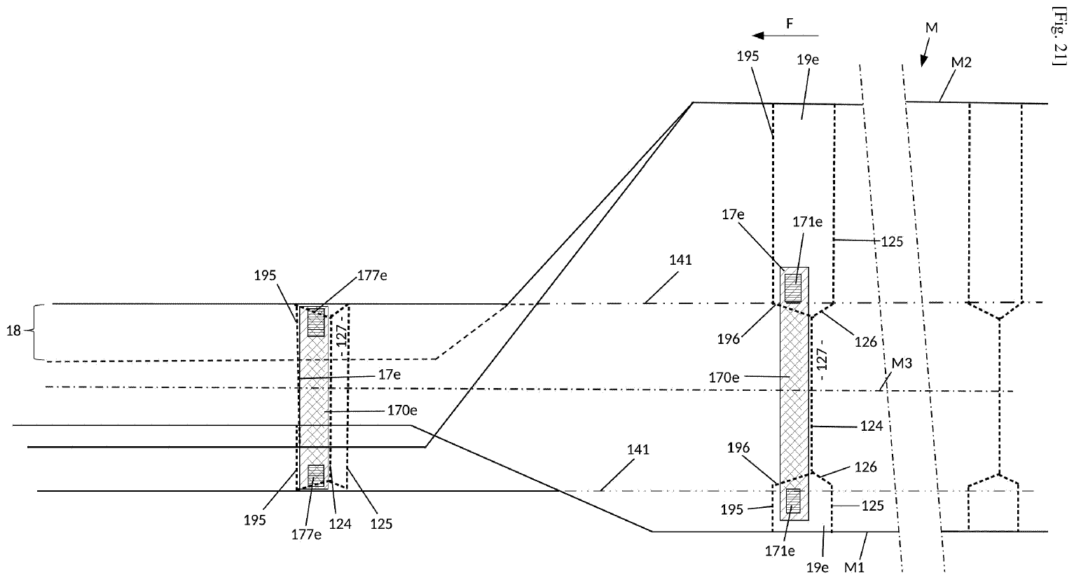

With reference to [FIG. 20], for the manufacture of an envelope 1d as per the fifth accomplishment mode, or of a variant of the fifth accomplishment mode with bellows 18, the precut areas 19 are identical to those in [FIG. 16]. However, the coat of closing adhesive 170d extends from hem 15 to hem 15, upstream of the cutting line 123 and downstream of the future upper edge 113. The protection strip 17d extends over the whole surface of the coat of closing adhesive 170d and protrudes beyond the edges M1, M2. The left-hand part of the figure represents the envelope 1 after cutting and after the folding of the upper flap 11d onto the lower flap 12d. After folding, the part of the protection strip 176 is located inside the envelope 1 opposite the other part 175.

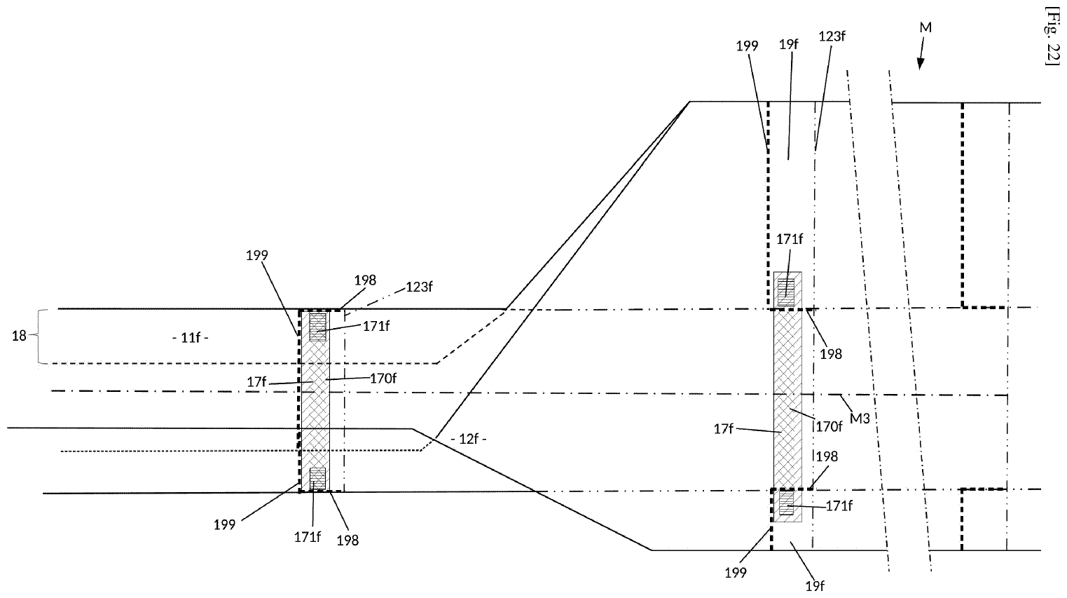

Optionally, the two parts of the protection strip 176, 175 are stuck together with reinforced adhesive 171d stronger than that of the coat of closing adhesive 170 in a unifying area 177. This unifying area 177 is situated on the sections 1760, 1750 of the parts 175, 176 of the protection strip 17d which extend beyond the hems 15 and into an area where the flaps 11d, 12d overlap. We have been able to apply two areas of reinforced adhesive 171d on the sections 1760, 1750 before folding so that these parts 176, 175 stick together when they are joined at the time of folding.

[FIG. 21] represents the manufacture of envelopes le as per the sixth accomplishment mode. The lower part of the figure shows the manufacture of an envelope le with one side without bellows and the upper part, above the middle line M3, an envelope le with one side with a bellows 18. In practice, the envelope le will not have any bellows or will have bellows 18 on both sides. In the manufacturing mode shown, the sheet M of flexible material is first of all unreeled and perforations are made, as shown on the right of [FIG. 21]. These perforation lines comprise a central line 124 extending in the transversal direction and situated between the future creases of the sides 141 of the envelope 1. The perforation lines also comprise a bottom line 125 that is also transversal and extends upstream of the central line 124, on both sides of the latter's ends, with an oblique junction line 126. Precut lines 195 extend in parallel with the bottom line 125, downstream of the central line 124, joining the central line 124 with oblique precut lines 196 and delimit the precut areas 19e with the bottom line.

Closing adhesive is applied creating a coat of closing adhesive 170e partially covering the oblique precut lines 196 between the future creases of the sides 141 and reinforced adhesive 171e is applied in the prolongation of the closing adhesive 170e beyond the future creases of the sides 141. The protection strip 17e is applied extending transversely and completely covering the adhesive areas 170e and 171e.

The middle part of [FIG. 21] shows a tube formation phase in which the edges M1, M2 are folded over the central area of the sheet along the creases of sides 141. The folded parts overlap and adhesive is applied to this overlapped part beforehand, not shown, to form the upper flap 11. The upper part of the figure also shows the formation of a bellows 18, in a way known per se and not detailed here.

After the formation of a tube, it passes into a tear-off station that ensures the separation function making it possible to separate a section at the front of the tube. This is a conventional type of station and is not described here. However, it should be noted that the tube is pinched on the one hand over the protection strip 17 and on the other hand upstream of the bottom line 125 to exert a traction force in the axial direction and obtain the separation of the section along the bottom line 125 and the central line 124. A front tab is thus obtained on the end of the tube that protrudes forwards from the lower flap 12. The section has been provided with this same front tab during the previous cycle in such a way that the tab is used to close the front end of the section and thus form the envelope le. An envelope le is thus obtained as shown in [FIG. 12].

In a variant, shown in [FIG. 22], for the manufacture of envelopes as per the seventh accomplishment mode, a tube is formed in a similar way. In the manufacturing mode shown, the sheet M of flexible material is first of all unreeled and provided with precut lines, as shown on the right of [FIG. 22]. A future cutting line 123f is represented with a two-dot and one-dash line along which the tube will be cut to separate a section. The precut lines comprise an eighth section 198 which extends along the future side crease from the cutting line in the downstream direction and a ninth segment 199 that extends transversely from the end of the eighth segment 198 to the edge M1, M2. The precut areas 19f are delimited between the eighth, the ninth segments 198, 199 and the future cutting line 123f.

Closing adhesive is applied creating a coat of closing adhesive 170f partially covering the eighth segments 198, and the reinforced adhesive 171f is applied in the prolongation of the closing adhesive 170f beyond the eighth segments. The protection strip 17f is applied extending transversely completely covering the adhesive areas 170f, 171f. The formation of the tube is identical to the variant in [FIG. 21].

After a tube has been formed, it passes into a cutting station 28 which makes it possible to separate a section at the front of the tube along the cutting line. The cut is a clean cut made by shearing, even though it could also be obtained by tearing as previously. The formation of the bottom by the folding means is not detailed.

In a variant, not shown, applicable to the sixth and seventh accomplishment modes, the precut segments can be made after the formation of the tube, upstream or downstream of the formation of the bottom, by a cutting station that makes it possible, by clamping together several layers of material, to cut all the layers except one, that of the lower flap. The cutting of the fifth segment 195 or of the ninth segment 199 is thus done.

The invention is not limited to the accomplishment modes described as examples. The variants with several protection strips can be adapted to the formation of tube- shaped envelopes. The replacement of gluing with reinforced adhesive can be achieved, as described as a variant to the first accomplishment mode for envelope 1, by using protection strips that do not have an anti-adhesion coat opposite the reinforced bonding areas, and the same adhesive as for the closing adhesive areas.

What is claimed is:

1. An envelope formed by at least one sheet of flexible material and comprising:
a lower flap,
an upper flap superposed over the lower flap, the flaps being joined together by lateral edges leaving an opening between the lateral edges,
at least one protection strip on one coat of closing adhesive, the coat of closing adhesive being designed to ensure the closing of the envelope after removal of the protection strip,
along the opening, at least one precut area that can be detached from the envelope, the coat of closing adhesive extending at least partially over the precut area wherein the envelope comprises reinforced means of linking joining the precut area to the protection strip in a reinforced way with respect to the link between the protection strip and the coat of closing adhesive.

2. The envelope according to claim 1, in which the reinforced means of linking comprises a coat of reinforced adhesive on the precut area and is covered by the protection strip, the protection strip adhering better to the coat of reinforced adhesive than to the coat of closing adhesive.

3. The envelope according to claim 1, in which the precut area is folded onto the back of the protection strip, the coat of closing adhesive on the precut area being stuck to said back of the protection strip, the reinforced means of linking being formed by the back of the protection strip adhering better to the coat of closing adhesive than the face opposite the back adheres to the coat of closing adhesive.

4. The envelope according to claim 1, in which the flaps are linked along the lateral edges by bellows, each bellows comprising two cheeks.

5. The envelope according to claim 4, in which the precut area extends over the whole width of the bellows at least.

6. The envelope according to claim 1, wherein the envelope comprises at least two protection strips in parallel in a transversal direction, and at least one precut area for each protection strip.

7. The envelope according to claim 1, in which the edges of the upper flap and of the lower flap at the level of the opening are offset with respect to each other to leave a tab area extending over the lower flap between said edges, the protection strip extending over the tab area.

8. The envelope according to claim 7, in which the coat of closing adhesive is subdivided into a first, second and third part extending transversely, the lower flap comprising a first and second weakening line between the first and second part, respectively the second and third part, the protection strip comprising a third weakening line aligned with the first weakening line and a fourth weakening line aligned with the second weakening line, the weakening lines extending across the precut area.

9. The envelope according to claim 1, in which the protection strip and the coat of closing adhesive are covered at least partially by the upper flap.

10. The envelope according to claim 9, in which the protection strip and the coat of closing adhesive extend over the whole periphery of the opening.

11. The envelope according to claim 1, in which the upper flap and the lower flap extend from the same sheet shaped into a tube and stuck edge to edge.

12. Envelope as per The envelope according to claim 11, in which the edges of the flaps along the opening are aligned.

13. The envelope according to claim 11, in which the edge of the upper flap along the opening extends beyond the lower flap, the precut area extending over the whole width of the upper flap set back from the edge of the lower flap.

14. The envelope according to claims 1 in which the upper flap and the lower flap extend from the same sheet of material folded along a transversal folding crease, perpendicular to the lateral edges of the flaps, towards an interior face, the envelope comprising a hem formed on each lateral edge, the hem of the upper flap being stuck to the hem of the lower flap on seam faces.

15. The envelope according to claim 14, in which the hem is stuck to the face opposite the seam face along either the upper flap or the lower flap.

16. The envelope according to claim 14, in which the hem is linked to a central part of the flap by means of a cheek folded over the central part, in such a way that a bellows is formed by two cheeks joined by the hems stuck to each other.

17. A process for manufacturing an envelope whereby:
at least one strip of flexible material in a continuous sheet is unreeled in a longitudinal direction,
the precut lines (191, 192, 193, 194) are marked delimiting precut areas (19) on the strip,
closing adhesive is applied extending on both sides of the precut lines, and a protection strip which covers the coat of closing adhesive at least outside the precut areas, in such a way that the precut area is linked to the protection strip in a strengthened way with respect to the link between the protection strip and the coat of closing adhesive,
the strip is separated into sections, and each section is closed to form an envelope as per one of the previous claims that has an opening bordered by the precut areas.

18. The process according to claim 17, whereby:
a hem is formed with a hemmer on each edge of the sheet before folding, and adhesive is applied to the hems over at least one length of an upper or lower flap on one seam face,
using a folding means, a fold of the strip is made along a transversal folding crease to fold the upper flap onto the lower flap against an interior face of the strip, the folding means bringing for each edge hem against hem by the seam face in such a way as to obtain the adhesion of the hems to each other to join the upper flap and the lower flap along the edges,
the sheet is cut by a transversal cut made by cutting means to form a section before or after the folding of the flaps one onto the other, the section forming the envelope at the end of the operations.

19. The process according to claim 18, whereby the transversal cut extends onto the protection strip to separate the protection stripinto a first part on the upper flap and a second part on the lower flap, the first part and the second part being at least partially superposed after folding.

20. The process according to claims 17, whereby, to make an envelope, the first and third weakening lines, respectively the second and fourth weakening line are marked together, after application of the protection strip on the sheet.

21. The process according to claims 17, for the manufacture of an envelope, whereby transversal perforation lines are made on the strip delimiting a rear end of a first envelope and a front tab of a second envelope following the first between a central line in the transversal direction and a bottom line from which the front tab protrudes forwards, the bottom line also delimiting the precut area, the sheet is shaped into a tube, then the first and second envelope are separated by axial traction on the tube by gripping the first envelope on the precut areas so that the separation is made along the central line and the bottom line.

22. Machine A machine for manufacturing flexible envelopes, characterised by the fact it comprises comprising:
unwinding means for unreeling at least one sheet of flexible material in a continuous sheet in a longitudinal direction,
marking means for marking precut lines on the sheet delimiting precut areas,
application means for applying a coat of closing adhesive at regular intervals, extending on both sides of the precut lines on the sheet, and a protection strip that covers the coat of closing adhesive at least outside the precut areas,
separation means for separating the sheet into sections along the rear edge of the section,
folding means for closing each section to form an envelope as per one of the previous claims with an opening along the rear edge bordered by the precut areas,
the machine being configured to implement the process.
